(19) United States
(12) Patent Application Publication
(10) Pub. No.: US 2007/0129028 A1
(43) Pub. Date: Jun. 7, 2007

(54) Radio-frequency circuit realizing stable operation

(76) Inventor: Yasuharu Kudo, Fukushima-ken (JP)

Correspondence Address: BEYER WEAVER LLP, P.O. BOX 70250, OAKLAND, CA, 94612-0250, US

(21) Appl. No.: 11/602,747

(22) Filed: Nov. 20, 2006

(30) Foreign Application Priority Data
Dec. 5, 2005 (JP) 2005-350395

(51) Int. Cl. H04B 1/04; H04N 7/16

(52) U.S. Cl. 455/120; 725/148

(57) ABSTRACT

A television signal transmitter has an up-converter provided with a pre-amplifier and an impedance matching circuit subsequent to the pre-amplifier. The self-resonance frequency of an inductor included in the impedance matching circuit, which is connected in series to a signal line, is set to a parasitic oscillation frequency (5 GHz) of the pre-amplifier. The self-resonance frequency of an inductor of a filter provided prior to the pre-amplifier, which is connected in series to the signal line, is set to the parasitic oscillation frequency (5 GHz) of the pre-amplifier.

### BACKGROUND OF THE INVENTION

1. Field of the Invention

The present invention relates to a radio-frequency circuit in which a variable-load circuit is connected to the input or output side of a radio-frequency amplifier circuit.

2. Description of the Related Art

A known television signal transmitter located at a community antenna television (CATV) station up-converts a television signal in an intermediate frequency band (hereinafter referred to as an “IF signal”) into a television signal of a channel to be transmitted (hereinafter referred to as an “RF signal”) and transmits the RF signal to a cable connected to the television signal transmitter (for example, see Japanese Unexamined Patent Application Publication No. 2001-94889).

FIG. 3 is a circuit diagram showing the structure of main portions of a known television signal transmitter. In the television signal transmitter shown in FIG. 3, an IF signal frequency-converted by a first mixer (not shown) is input to a second mixer 11. The second mixer 11 mixes a local oscillation signal input from a local oscillator 12 and the IF signal input from the first mixer and frequency-converts the combined signal into an RF signal. A filter 13 provided at an output stage of the second mixer 11 removes spurious components, and thereafter a pre-amplifier 14 serving as a radio-frequency amplifier circuit amplifies the RF signal. The RF signal output from the pre-amplifier 14 is input to a variable attenuator 15, which in turn controls the output level of the RF signal. An impedance matching circuit 19 for matching the impedance of the pre-amplifier 14 and the impedance of a circuit portion subsequent to the pre-amplifier 14 is connected between the pre-amplifier 14 and the variable attenuator 15. A plural-stage amplifier 16 (only a first stage is shown in FIG. 3), which is cascade-connected to an output stage of the variable attenuator 15, sequentially amplifies the RF signal, and a band-pass filter 17 removes unnecessary spurious components. The RF signal, which has been up-converted in this manner, is transmitted from a power amplifier 18 onto a cable.

In the known television signal transmitter, due to a change in the impedance of a load connected to the output side of the pre-amplifier 14 or a change in the impedance at the input side of the pre-amplifier 14, parasitic oscillation of the pre-amplifier 14 serving as the radio-frequency amplifier circuit may occur in a frequency band (e.g., at frequencies near 5 GHz) higher than the pass-band (e.g., 47 MHz to 870 MHz) of the pre-amplifier 14.

### SUMMARY OF THE INVENTION

Accordingly, it is an object of the present invention to provide a highly reliable radio-frequency circuit realizing the stable operation while preventing parasitic oscillation of a radio-frequency amplifier circuit due to a load change prior or subsequent to the radio-frequency amplifier circuit.

A radio-frequency circuit according to a first aspect of the present invention includes a radio-frequency amplifier circuit; and an impedance matching circuit connected to an output end of the radio-frequency amplifier circuit. The impedance matching circuit has an inductor. A variable-load circuit is connected subsequent to the impedance matching circuit. A self-resonance frequency of the inductor is set to a parasitic oscillation frequency of the radio-frequency amplifier circuit or to a frequency in the vicinity of the parasitic oscillation frequency.

With this structure, the self-resonance frequency of the inductor of the impedance matching circuit is set to the parasitic oscillation frequency of the radio-frequency amplifier circuit or to a frequency in the vicinity of the parasitic oscillation frequency. Therefore, the inductor presents high impedance at the parasitic oscillation frequency of the radio-frequency amplifier circuit. At the parasitic oscillation frequency, an influence of the load of the circuit connected subsequent to the impedance matching circuit may be avoided, thereby preventing parasitic oscillation of the radio-frequency amplifier circuit.

Preferably, the impedance matching circuit is a low-pass filter type having the inductor connected in series to a signal line.

A radio-frequency circuit according to another aspect of the present invention includes a radio-frequency amplifier circuit; and a filter connected to an input end of the radio-frequency amplifier circuit. The filter has an inductor. A variable-load circuit is connected prior to the filter. A self-resonance frequency of the inductor is set to a parasitic oscillation frequency of the radio-frequency amplifier circuit or to a frequency in the vicinity of the parasitic oscillation frequency.

With this structure, the self-resonance frequency of the inductor of the filter is set to the parasitic oscillation frequency of the radio-frequency amplifier circuit or to a frequency in the vicinity of the parasitic oscillation frequency. Therefore, the inductor presents high impedance at the parasitic oscillation frequency of the radio-frequency amplifier circuit. At the parasitic oscillation frequency, an influence of the load of the circuit connected prior to the radio-frequency amplifier circuit may be avoided, thereby preventing parasitic oscillation of the radio-frequency amplifier circuit.

Preferably, the filter is a low-pass filter having a combination of inductors and capacitors, and the inductors are connected in series to a signal line.

According to the embodiments of the present invention, parasitic oscillation of a radio-frequency amplifier circuit due to a load change prior or subsequent to the radio-frequency amplifier circuit in a radio-frequency circuit is prevented.

### BRIEF DESCRIPTION OF THE DRAWINGS

FIG. 1 is a circuit diagram showing portions including a filter and a pre-amplifier of a television signal transmitter according to an embodiment of the present invention;

FIG. 2 is a circuit diagram showing portions including a filter and a pre-amplifier of a television signal transmitter according to a modification in which a different inductor is used for presenting high impedance; and

FIG. 3 is a diagram showing the entirety of a television signal transmitter.

### DESCRIPTION OF THE PREFERRED EMBODIMENTS

Embodiments of the present invention will be described in detail with reference to the accompanying drawings.

An embodiment of the present invention applied to an up-converter of a television signal transmitter will be described.

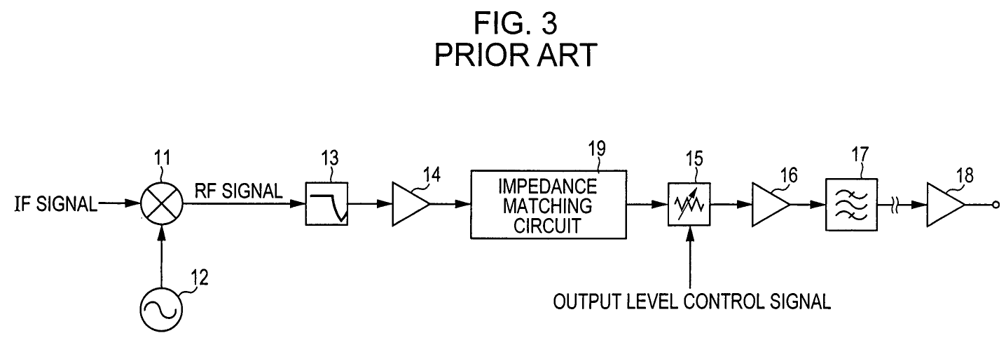

The television signal transmitter according to the embodiment of the present invention has the same overall structure as that of a television signal transmitter shown in FIG. 3. That is, the television signal transmitter includes a second mixer 11, a local oscillator 12, a filter 13, a pre-amplifier 14 serving as a radio-frequency amplifier circuit, a variable attenuator 15, a plural-stage amplifier 16, a band-pass filter 17, and a power amplifier 18.

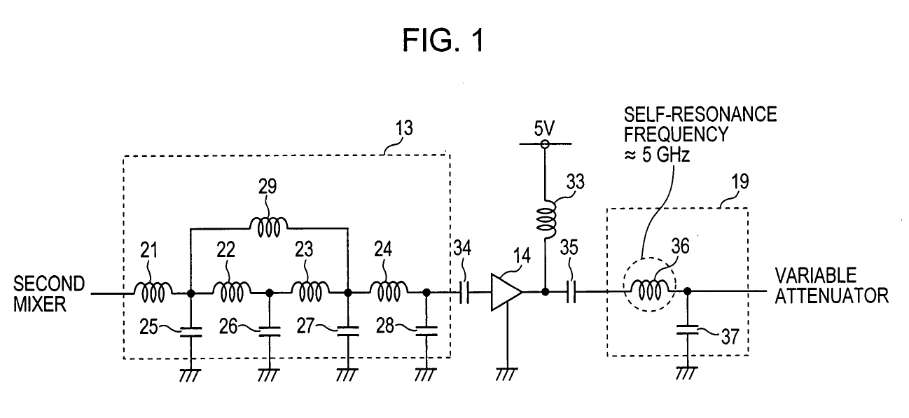

FIG. 1 is a circuit diagram showing the structure of portions including the filter 13 and the pre-amplifier 14.

The filter 13 realizes desired characteristics by combining a plurality of inductors and capacitors. Specifically, inductors 21 to 24 are cascade-connected in series to a signal line, and nodes between the inductors 21 to 24 and the signal line are connected to ground via associated capacitors 25 to 28. An inductor 29 is connected in parallel with the inductors 22 and 23. In the filter 13 having this structure, the pass-band of the filter 13 corresponds to, for example, an RF signal from 47 MHz to 870 MHz, and the filter 13 realizes such characteristics that frequencies higher than the pass-band are attenuated while a trap is provided in an area where unnecessary frequencies near the pass-band appear.

The pre-amplifier 14 includes a transistor. A collector terminal of the transistor is connected to a feeder, and an emitter terminal of the transistor is connected to ground. Specifically, a feeder terminal is connected to the collector terminal of the transistor via an inductor 33. A DC cut capacitor 34 is provided at an input end of the pre-amplifier 14, and a DC cut capacitor 35 is provided at an output end of the pre-amplifier 14.

An impedance matching circuit 19 including an inductor 36 and a capacitor 37 is provided subsequent to the pre-amplifier 14. The impedance matching circuit 19 functions to match the impedance of the pre-amplifier 14 and the impedance of a circuit portion subsequent to the pre-amplifier 14 in the pass-band (47 MHz to 870 MHz) of the pre-amplifier 14. As has been described above, the impedance of a portion subsequent to the pre-amplifier 14 may change due to a load change. The inductor 36 is connected in series to a signal line connecting the output end of the pre-amplifier 14 to an input end of the variable attenuator 15. The capacitor 37 is provided between ground and an end of the inductor 36 on the side of the variable attenuator 15. In this example, the impedance matching circuit 19 is an LC parallel resonance circuit of a low-pass filter type.

The self-resonance frequency of the inductor 36, which is connected in series to the signal line connecting the output end of the pre-amplifier 14 to the input end of the variable attenuator 15, will be described.

In general, an inductor includes an inductor component (L) and a capacitor component (C) parallel with the inductor component (L). Thus, the inductor functions as an LC resonance circuit at its self-resonance frequency. For example, the inductor 36 including a chip inductor resonates at a predetermined self-resonance frequency. While resonating, the inductor 36 presents high impedance. When viewed from the pre-amplifier 14, the impedance of a circuit portion subsequent to the inductor 36 exerts no influence on the pre-amplifier 14.

In the embodiment, the inductor 36 is allowed to self-resonate at frequencies in the vicinity of a frequency at which parasitic oscillation of the pre-amplifier 14 occurs, thereby presenting high impedance. That is, the self-resonance frequency of the inductor 36 is set to the same frequency as the parasitic oscillation frequency of the pre-amplifier 14 or to a frequency in the vicinity of the parasitic oscillation frequency. The self-resonance frequency of the inductor 36 may be set within a range where the inductor 36 presents high impedance, which means that the range has a certain width. In the embodiment, it is assumed that parasitic oscillation of the pre-amplifier 14 occurs at frequencies near 5 GHz due to a load change subsequent to the impedance matching circuit 19, and the inductor 36 having a self-resonance frequency in the vicinity of 5 GHz is used.

The operation of the television signal transmitter with the above-described structure according to the embodiment of the present invention will be described.

An IF signal frequency-converted by a first mixer (not shown) is input to the second mixer 11. The second mixer 11 mixes a local oscillation signal input from the local oscillator 12 and the IF signal input from the first mixer and frequency-converts the combined signal into an RF signal. The RF signal output from the second mixer 11 is subjected to the filter 13, which removes signal components other than those within a pass-band of 47 MHz to 870 MHz as spurious components. The filtered television signal is amplified by the pre-amplifier 14, and thereafter input via the impedance matching circuit 19 to the variable attenuator 15.

In this case, the impedance matching circuit 19 functions to match the impedance of the pre-amplifier 14 and the impedance of a circuit portion subsequent to the pre-amplifier 14 in the pass-band of 47 MHz to 870 MHz, thereby reducing transmission loss due to reflection. At frequencies near 5 GHz, which is the self-resonance frequency of the inductor 36, the inductor 36 presents high impedance. When viewed from the pre-amplifier 14, an influence of the load of a circuit (including a cable) connected to the output side of the impedance matching circuit 19 can be avoided. Therefore, the pre-amplifier 14 is shielded from a load connected to the output side of the impedance matching circuit 19 at frequencies near 5 GHz, and hence parasitic oscillation at frequencies near 5 GHz is prevented.

The television signal input to the variable attenuator 15 is level-adjusted, and the level-adjusted signal is transmitted via the subsequent amplifier 16 and the band-pass filter 17 from the power amplifier 18 onto a cable as a television signal of a channel from 47 MHz to 870 MHz.

According to the embodiment of the present invention, the inductor 36 is allowed to self-resonate at frequencies near the frequency at which parasitic oscillation of the pre-amplifier 14 occurs, thereby presenting high-impedance. Therefore, parasitic oscillation of the pre-amplifier 14 at frequencies near 5 GHz due to a load change subsequent to the impedance matching circuit 19 can be prevented. Since the inductor 36 of the impedance matching circuit 19 provided at the output stage of the pre-amplifier 14 is used, there is no need to provide an additional resonance circuit for preventing parasitic oscillation. Therefore, the number of components is not increased at all.

In the above description, the inductor 36 connected to the output end of the pre-amplifier 14 prevents parasitic oscillation due to a load change subsequent to the impedance matching circuit 19. In addition, parasitic oscillation of the pre-amplifier 14 due to a change in the load of a circuit connected prior to the pre-amplifier 14 can be prevented by selecting the self-resonance frequency of an inductor connected to the input end of the pre-amplifier 14.

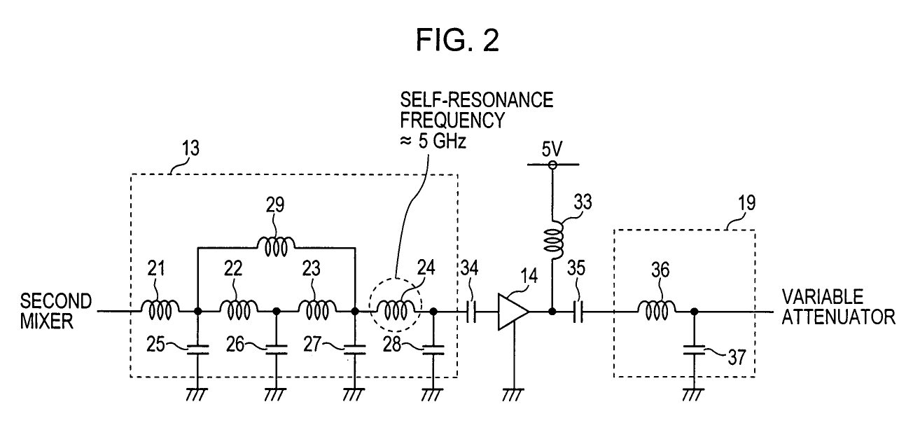

As shown in FIG. 2, it is preferable to use an inductor that is connected in series to the signal line for inputting the RF signal output from the second mixer 11 to the pre-amplifier 14 and that is closest to the pre-amplifier 14, namely, the inductor 24. The inductor 24 is one of the inductors included in the filter 13. It is to be noted that the present invention is not limited to the case where the inductor 24 is used, and another inductor (e.g., the inductor 23) may be used to present high impedance at frequencies near the parasitic oscillation frequency.

It is assumed that parasitic oscillation of the pre-amplifier 14 occurs at frequencies near 5 GHz due to a change in the load of a circuit (e.g., the filter 13) connected prior to the pre-amplifier 14. In this case, the inductor 24 having a self-resonance frequency of around 5 GHz is used.

In the case of the filter 13 provided with the inductor 24 having its self-resonance frequency of around 5 GHz, a television signal from 47 MHz to 870 MHz is allowed to flow to the pre-amplifier 14, and the inductor 24 self-resonates at frequencies near 5 GHz, thereby presenting high impedance. Since the inductor 24 presents high impedance at frequencies near 5 GHz, when viewed from the pre-amplifier 14, an influence of the load of a circuit connected prior to the inductor 24 can be avoided. Therefore, the pre-amplifier 14 is shielded from a load connected prior to the inductor 24 at frequencies near 5 GHz, and hence parasitic oscillation at frequencies near 5 GHz is prevented.

In the above description, the self-resonance frequencies of the inductor 36 of the impedance matching circuit 19 and the inductor 24 of the filter 13 are set to frequencies near 5 GHz. Alternatively, when parasitic oscillation of the pre-amplifier 14 occurs at different frequencies depending on the previous-stage load and the subsequent-stage load, the self-resonance frequencies of the previous-stage inductor 24 and the subsequent-stage inductor 36 may be set to different values according to the associated parasitic oscillation frequencies.

The present invention is not limited to a television signal transmitter located at a CATV station and is applicable to other radio-frequency circuits with a radio-frequency amplifier circuit.

The present invention is applicable to a radio-frequency circuit in which a variable-load circuit is connected to the input or output side of a radio-frequency amplifier circuit.

What is claimed is:

1. A radio-frequency circuit comprising:
a radio-frequency amplifier circuit; and
an impedance matching circuit connected to an output end of the radio-frequency amplifier circuit, the impedance matching circuit having an inductor, a variable-load circuit being connected subsequent to the impedance matching circuit,
wherein a self-resonance frequency of the inductor is set to a parasitic oscillation frequency of the radio-frequency amplifier circuit or to a frequency in the vicinity of the parasitic oscillation frequency.

2. The radio-frequency circuit according to claim 1, wherein the impedance matching circuit is a low-pass filter type having the inductor connected in series to a signal line.

3. A radio-frequency circuit comprising:
a radio-frequency amplifier circuit; and
a filter connected to an input end of the radio-frequency amplifier circuit, the filter having an inductor, a variable-load circuit being connected prior to the filter,
wherein a self-resonance frequency of the inductor is set to a parasitic oscillation frequency of the radio-frequency amplifier circuit or to a frequency in the vicinity of the parasitic oscillation frequency.

4. The radio-frequency circuit according to claim 3, wherein the filter is a low-pass filter having a combination of inductors and capacitors, the inductors being connected in series to a signal line.

5. A television signal transmitter comprising an up-converter having a radio-frequency circuit as set forth in claim 1.

6. A television signal transmitter comprising an up-converter having a radio-frequency circuit as set forth in claim 3.
